(19) United States
(12) Patent Application Publication
(10) Pub. No.: US 2017/0148333 A1
(43) Pub. Date: May 25, 2017

(54) METHOD FOR AUTOMATICALLY PILOTING AN AIRCRAFT ON THE GROUND AND DEVICE FOR ITS IMPLEMENTATION

(71) Applicant: Airbus SAS, Blagnac (FR)

(72) Inventor: Diego ALONSO TABARES, Toulouse (FR)

(21) Appl. No.: 15/347,990

(22) Filed: Nov. 10, 2016

(30) Foreign Application Priority Data
Nov. 19, 2015 (FR) 1561119

(51) Int. Cl. G08G 5/06

(52) U.S. Cl. CPC G08G 5/065

(57) ABSTRACT

A method and a device for automatically piloting an aircraft on the ground comprises, when an activation control present in the cockpit of the aircraft is activated, the steps of and apparatus for determining at least one sequence of taxiing instructions as a function of static and dynamic characteristics of the aircraft and of a taxiing path to be traversed, and transmitting the determined sequence of taxiing instructions to the command system piloting the displacement systems of the aircraft so that the aircraft traverses the taxiing path.

### CROSS-REFERENCES TO RELATED APPLICATIONS

This application claims the benefit of the French patent application No. 1561119 filed on Nov. 19, 2015, the entire disclosures of which are incorporated herein by way of reference.

### BACKGROUND OF THE INVENTION

The invention pertains to a method for automatically piloting an aircraft on the ground as well as to a device for its implementation.

An airport comprises at least one landing runway, several parking points and numerous taxiways to connect each landing runway to certain parking points.

After it lands, the aircraft performs a taxiing phase which goes from a landing runway to a parking point. During this taxiing phase, the aircraft is piloted manually so as to traverse a taxiing path determined by the pilot on the basis of instructions transmitted by an air traffic control post.

Having regard to the complexity of certain airports, the taxiing phase can give rise to disruption of the airport traffic flow and therefore delays for passengers.

To simplify this taxiing phase, document FR-2,902,221 proposes a method for aiding ground navigation. According to this document, an alert signal informs the pilot if at least one real position of the aircraft does not lie on a taxiway or if the real orientation of the aircraft does not correspond to the direction of traffic flow for a given taxiway.

This method is not fully satisfactory since it informs the pilot only a posteriori, once the error has arisen. It does not provide for the prevention of errors.

At the parking point, the aircraft must be at a standstill in a given stopping position with a stopping orientation.

When approaching the parking point, the pilot follows instructions indicated by an exterior assistance to halt and orient the aircraft correctly.

According to a first operative mode called “marshalling”, the instructions are given by a ground operator (possibly accompanied by a car providing luminous dynamic indications) and take the form of visual directives which are dependent on the signaling gestures made by the ground operator.

According to a second operative mode called VDGS (for “Visual Docking Guidance System”), the instructions take the form of visual directives which are displayed on a screen positioned facing the aircraft.

In both cases, the directives being visual, there is a risk when approaching the parking point that the pilot's view of the directives will be poor. This risk is accentuated when the climatic conditions are poor.

According to another drawback, the two operative modes of the prior art lead to a lack of precision and a non-repeatability relating to the position and the orientation in which the aircraft stops at the parking point. This lack of precision and non-repeatability make it difficult to automate certain operations and must be compensated for by more complex airport installations.

### SUMMARY OF THE INVENTION

Hence, the present invention is aimed at remedying the drawbacks of the prior art.

For this purpose, a subject of the invention is a method for automatically piloting an aircraft on the ground, the aircraft comprising a cockpit, displacement systems, at least one command system configured to pilot the displacement systems and at least one manual control configured to transmit at least one instruction to the command system(s).

According to the invention, the method is characterized in that it comprises, when an activation control present in the cockpit is activated, the steps of:

determination of at least one sequence of taxiing instructions as a function of static and dynamic characteristics of the aircraft and of a taxiing path to be traversed,

transmission of the determined sequence of taxiing instructions to the command system(s) piloting the displacement systems of the aircraft so that the aircraft traverses the taxiing path.

The invention makes it possible to obtain better regularity relating to the precision of the position and of the orientation in which the aircraft stops at the end of the taxiing path. Moreover, the invention makes it possible to remove the risks of poor viewing and/or interpretation of visual directives.

Advantageously, the method comprises a step of adjusting the dynamic characteristics of the aircraft as a function of at least one characteristic of the climatic conditions.

Preferentially, the method comprises the steps aimed at:

carrying out a comparison between a real value of a characteristic of the aircraft determined by a measurement system and a theoretical value of this characteristic,

determining, as a function of the comparison, at least one corrective taxiing instruction,

transmitting the determined corrective taxiing instruction to the command system(s).

According to one embodiment, the taxiing path to be traversed is determined with the help of a database and of a directive transmitted to the aircraft by an air traffic control post.

According to another characteristic, the method comprises a step aimed at choosing the taxiing path to be traversed from among a list of possible taxiing paths.

Preferably, the method comprises a step of verifying that the taxiing path to be traversed can be accomplished.

The subject of the invention is also a device for automatically piloting an aircraft on the ground, which is characterized in that it comprises:

a database comprising static and dynamic characteristics of the aircraft to make it possible to determine at least one sequence of taxiing instructions,

an activation control positioned in the cockpit and configured to be actuated by a pilot,

an automatic control system configured to:

determine in an automatic manner at least one sequence of taxiing instructions to be executed as a function of a taxiing path to be traversed,

transmit the determined sequence of taxiing instructions to the command system(s) piloting the displacement systems so that the aircraft traverses the taxiing path.

Advantageously, the device comprises at least one system for measuring at least one characteristic of the climatic conditions and the control system is configured to adjust the dynamic characteristics of the aircraft as a function of the measured characteristic of the climatic conditions.

Preferably, the device comprises a measurement system configured to determine a real value of a characteristic of the aircraft and the automatic control system comprises a computer configured to:

carry out a comparison between the real value of the characteristic of the aircraft determined by the measurement system and a theoretical value of this characteristic, and

determine as a function of the comparison at least one corrective taxiing instruction to be transmitted to the command system(s).

According to another characteristic, the database comprises information to make it possible to determine the taxiing path to be traversed.

According to one embodiment, the device comprises a viewing screen and/or an input system configured to allow a pilot to input a directive transmitted by an air traffic control post and/or a wireless communication system configured to allow a ground operator to transmit taxiing instructions to the command system(s) of the aircraft.

### BRIEF DESCRIPTION OF THE DRAWINGS

Other characteristics and advantages will emerge from the following description of the invention, which description is given solely by way of example, with regard to the appended drawings in which:

FIG. 1 is a view from above of an airport which illustrates an example of a taxiing path followed by an aircraft,

FIG. 2 is a diagram of a device for automatically piloting an aircraft on the ground which illustrates an embodiment of the invention.

### DETAILED DESCRIPTION OF THE PREFERRED EMBODIMENTS

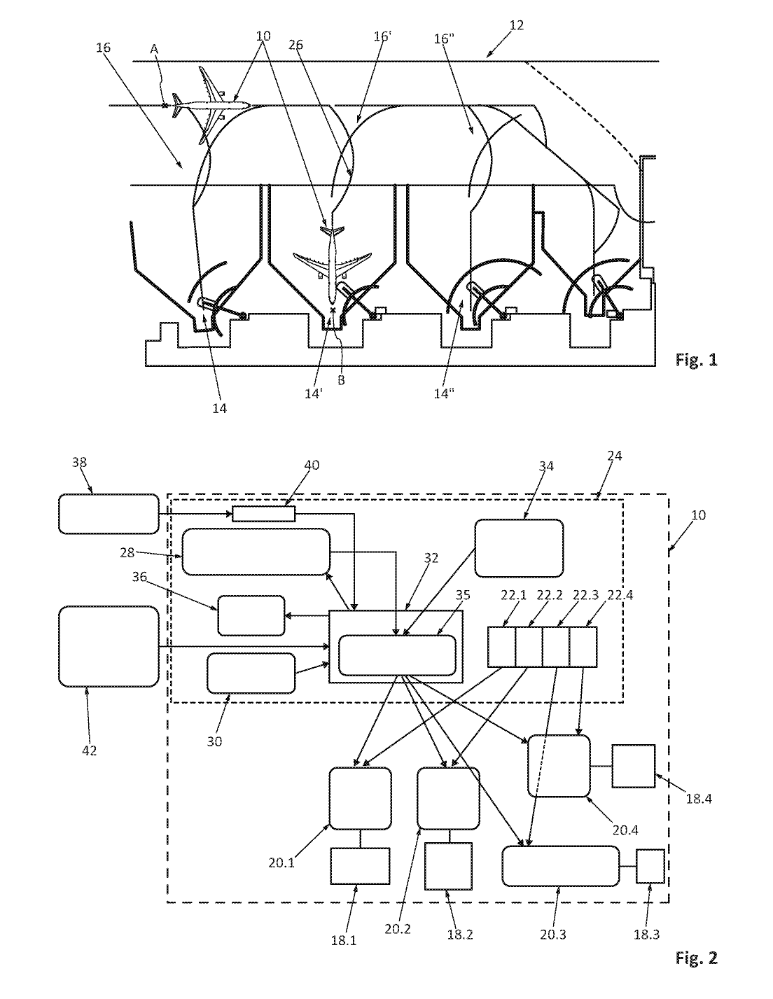

Represented in FIG. 1 is an aircraft 10 travelling around in an airport 12.

This airport 12 comprises at least one landing runway (not represented), parking points 14, 14′, 14″ and taxiways 16, 16′, 16″ which connect each landing runway to certain parking points 14, 14′, 14″. Each landing runway, each taxiway 16, 16′, 16″ and each parking point 14, 14′, 14″ comprises an identifier.

In FIG. 2, the aircraft 10 is schematically represented in the form of a dashed rectangle. To move and come to a standstill on the ground, the aircraft 10 comprises displacement systems 18.1 to 18.4, at least one command system 20.1 to 20.4 configured to command the displacement systems 18.1 to 18.4 and at least one manual control 22.1 to 22.4 configured to transmit at least one instruction to the command system(s) 20.1 to 20.4 and forming an interface between a pilot and the command system(s) 20.1 to 20.4.

By displacement system is meant a subset of the aircraft 10 configured to allow the aircraft 10 to move, orient itself, come to a standstill on the ground.

By way of example, the aircraft 10 comprises:

a first displacement system 18.1 of steering type configured to modify the orientation of the aircraft 10,

a second displacement system 18.2 of braking type configured to bring the aircraft 10 to a standstill,

a third displacement system 18.3 of propulsion type configured to displace the aircraft 10,

a fourth displacement system 18.4 of electric motorization type configured to rotate at least one wheel of the aircraft 10.

According to a configuration visible in FIG. 2, each displacement system 18.1 to 18.4 is piloted by a command system 20.1 to 20.4 dedicated thereto and each command system 20.1 to 20.4 is connected to a manual control 22.1 to 22.4 dedicated thereto.

According to other configurations, one and the same command system and/or one and the same manual control pilots several displacement systems.

The aircraft 10 comprises a cockpit 24 in which the previously cited manual controls 22.1 to 22.4 are positioned.

The cockpit 24, the manual controls 22.1 to 22.4, the command systems 20.1 to 20.4 and the displacement systems 18.1 to 18.4 are not described further since they are known to the person skilled in the art.

In the airport, the aircraft 10 performs a taxiing phase during which the pilot carries out several taxiing maneuvers so that the aircraft 10 traverses a taxiing path 26 that goes from a starting point to a finishing point and that passes through at least one taxiway. The term taxiing maneuver is intended to mean the actions carried out by the pilot on the various manual controls 22.1 to 22.4. The starting and finishing points can be a landing or takeoff runway, a parking point or a maintenance area or any other infrastructure of the airport 12.

A taxiing path 26 corresponds to a succession of theoretical positions that the aircraft 10 must successively occupy. Advantageously, a theoretical orientation of the aircraft 10 is associated with each theoretical position.

The position of the aircraft 10 is defined by the coordinates of a point of the aircraft 10 in a reference frame. By way of example, the GPS coordinates of a point of the aircraft 10 make it possible to indicate the position of the aircraft 10.

The orientation of the aircraft 10 corresponds to an angle formed by the longitudinal direction of the aircraft 10 (which runs from the nose to the tail of the aircraft 10) in a reference frame.

The taxiing maneuvers carried out by the pilot are converted into taxiing instructions which are transmitted to the command system(s) 20.1 to 20.4 which pilot the various displacement systems 18.1 to 18.4.

The term taxiing instruction is intended to mean at least one item of information transmitted to the command system(s) 20.1 to 20.4, such as, for example, orient the wheels of the landing gear of the fourth displacement system 18.4 or fix the thrust level of the engines of the third displacement system 18.3.

Thus, the taxiing instructions comprise:

instructions relating to piloting and to changes of direction and intended for the first displacement system 18.1 of steering type,

instructions relating to engine power and intended for the third displacement system 18.3 of propulsion type,

instructions relating to braking and intended for the second displacement system 18.2 of braking type.

Represented in FIG. 1 is a part of the taxiing path 26 which connects a point A to a point B. In the example visible in FIG. 1, the point B corresponds to the parking point 14′ and the taxiing path 26 follows the taxiway 16′.

According to the invention, the aircraft 10 comprises a ground automatic piloting device configured to displace alone, without the pilot's intervention, the aircraft 10 along the taxiing path 26 to be traversed.

This automatic piloting device comprises:

a database 28 comprising:

information relating to the infrastructure of the airport 12 to make it possible to determine the taxiing path 26 to be traversed,

static and dynamic characteristics of the aircraft 10 to make it possible to determine at least one sequence of taxiing instructions to be executed so that the aircraft 10 traverses the taxiing path 26,

an activation control 30 positioned in the cockpit 24 and configured to be actuated by a pilot,

an automatic control system 32 configured to, when the activation control 30 is actuated:

determine at least one sequence of taxiing instructions to be executed as a function of the taxiing path 26 to be traversed,

transmit the sequence of taxiing instructions to the command system(s) 20.1 to 20.4 so that the aircraft 10 traverses the taxiing path 26.

The sequence of taxiing instructions comprises as a minimum at least one taxiing instruction.

This sequence of taxiing instructions is determined in an automatic manner as a function of the taxiing path 26 to be traversed and of the static and dynamic characteristics of the aircraft 10 that are cataloged in the database 28.

Advantageously, the automatic piloting device comprises at least one system for measuring at least one characteristic of the climatic conditions and the control system 32 is configured to adjust the dynamic characteristics of the aircraft 10 as a function of the measured characteristic of the climatic conditions.

According to one embodiment, the aircraft 10 integrates a set of sensors such as pressure, temperature and moisture sensors so as to ascertain the climatic conditions and, in particular, the state of the ground and determine their impact on the performance of the aircraft 10, on its dynamic behavior and on the taxiing instructions.

Alternatively, the climatic conditions are transmitted to the pilot and/or to a ground operator by an element outside the aircraft 10 such as, for example, an air traffic control post or a ground operator.

Preferably, an instruction transmitted by the manual controls 22.1 to 22.4 has priority with respect to a sequence of taxiing instructions that is determined in an automatic manner by the automatic control system 32. Thus, at each instant, the pilot can resume command of the aircraft 10 by actuating at least one of the manual controls 22.1 to 22.4.

During this taxiing phase, the aircraft 10 follows a real trajectory which corresponds to a succession of real positions occupied by the aircraft 10. A real orientation is associated with each real position.

Advantageously, the automatic piloting device comprises a measurement system 34 for measuring, in real time, at least one real value of a characteristic of the aircraft 10 during the taxiing phase. By way of example, the characteristics of the aircraft 10 are its position, its orientation, its speed, its acceleration and/or any other dynamic characteristic.

For the present patent application, the adjective “real” qualifies characteristics relating to the actual displacement of the aircraft 10 in the airport during the taxiing phase, as opposed to the adjective “theoretical” which qualifies characteristics determined on the basis of the taxiing path 26 to be traversed and/or of the sequence of taxiing instructions that is associated with the taxiing path 26 to be traversed.

As a supplement, the automatic control system 32 comprises a computer 35 configured to:

carry out a comparison between the real value of the characteristic of the aircraft 10 determined by the measurement system 34 and a theoretical value of this characteristic,

determine at least one taxiing instruction to be transmitted to the command system(s) 20.1 to 20.4 as a function of the comparison so that the real trajectory of the aircraft 10 corresponds to the taxiing path 26 to be traversed.

Advantageously, the ground automatic piloting device comprises a viewing screen 36 configured to display at least the taxiing path 26 to be traversed. Preferably, the viewing screen 36 is configured to display, in addition to the taxiing path 26 to be traversed, at least one of the following items of information:

the identifier of the finishing point,

a map of the airport which makes it possible to view all the landing runways, taxiways 16, 16′, 16″, parking points 14, 14′, 14″, the taxiing path 26 to be traversed being clearly identified and displayed on the map,

a symbolic representation of the aircraft 10 which moves in real time on the taxiing path 26 to be traversed,

the remaining distance to be traversed and the theoretical duration of the displacement up to the finishing point.

Of course, the invention is not limited to these items of information.

According to another characteristic, the ground automatic piloting device determines the taxiing path 26 to be traversed with the help of the database 28 and of at least one directive transmitted to the aircraft 10 by an air traffic control post.

According to a first operative mode, the directive is included in a voice message 38 received by the pilot. In this case, the automatic piloting device comprises an input system 40, such as, for example, a keyboard, connected to the automatic control system 32 and configured to allow the pilot to input the directive received so as to advise the automatic control system 32.

According to a second operative mode, the directive is included in a message 42 interpretable directly by the automatic control system 32, with the aid of a communication aid device such as described in patent EP-2,674,926. With respect to the first embodiment, the second operative mode makes it possible to remove input from the pilot and to consequently reduce the risks of input errors.

According to one embodiment, the ground automatic piloting device comprises an offboard support housing the viewing screen 36 and the input system 40.

Advantageously, the automatic piloting device comprises a wireless communication system configured to allow a ground operator to transmit taxiing instructions to the command systems 20.1 to 20.4 of the aircraft 10.

The content of the database 28 differs from one model of aircraft 10 to another and integrates data relating to at least one airport, in particular, that in which the aircraft 10 is moving.

For each aircraft 10, the database 28 comprises static characteristics on the aircraft 10 which relate to the dimensions of the aircraft 10, such as its length, its empennage, its wingspan. The database 28 also contains dynamic characteristics relating to the performance of the aircraft 10, such as the thrust of the engines, the angle of rotation of the various landing gear, the power of an electric advancement device (if an e-taxi solution is installed on the aircraft 10), the steering characteristics of the braking system. Advantageously, these dynamic characteristics of the aircraft 10 are updated according to the climatic conditions.

For each airport indexed in the database 28, the database 28 contains detailed characteristics on the airport infrastructure and, in particular, all the characteristics required for the creation of a taxiing path 26. In a non-exhaustive manner, these characteristics comprise at least the landing runways, the taxiways, the parking areas (for passengers to board or disembark or for maintenance operations or else for a waiting phase between two flights), the entry and exit lines of each parking area, the stopping points, the guidance and pushback lines (“pushback” maneuver).

According to a first embodiment, for each airport, the database 28 catalogues all the taxiing paths 26 while associating an identifier with each of them. According to this first embodiment, the directive transmitted to the aircraft 10 comprises the identifier of the taxiing path 26 to be traversed and the automatic control system 32 is configured to extract the taxiing path 26 to be traversed from the database 28 on the basis of the identifier received.

According to a second embodiment, for each airport, the database 28 catalogues all the taxiing runways, all the parking points, each associated with a parking point identifier, and for each landing runway/parking point pair a taxiing path 26 to be traversed. According to this second embodiment, the directive transmitted to the aircraft 10 comprises the identifier of the parking point. Knowing the real position of the aircraft 10, the automatic control system 32 is configured to identify the landing runway on which the aircraft 10 has landed. Knowing the landing runway corresponding to the start of the taxiing path and the identifier of the parking point corresponding to the end of the taxiing path, the automatic control system 32 is configured to extract the taxiing path 26 to be traversed from the database 28.

According to a third embodiment, for each airport, the database 28 catalogues all the taxiing runways, all the parking points, each associated with a parking point identifier, and for each landing runway/parking point pair, at least one taxiing path 26. With respect to the second embodiment, a landing runway/parking point pair may be associated with several taxiing paths 26. According to this third embodiment, the directive transmitted to the aircraft 10 comprises the identifier of the parking point.

Knowing the identifier of the parking point corresponding to the end of the taxiing path 26, the automatic control system 32 is configured to extract a list of possible taxiing paths 26 from the database 28.

According to a first operative mode, the pilot chooses the taxiing path 26 to be traversed from among the list of possible taxiing paths 26, for example by using the input system 40.

According to a second operative mode, the automatic control system 32 automatically chooses the taxiing path 26 to be traversed from among the list of possible taxiing paths 26, as a function of the official traffic flow rules for the airport or of other criteria such as, for example, the shortest taxiing path 26.

According to another characteristic, the automatic control system 32 is configured to verify as a function of the real position of the aircraft 10 whether the taxiing path 26 to be traversed can be accomplished. Preferentially, the aircraft 10 comprises an anti-collision system coupled to the automatic control system 32 so as to identify, in particular, the mobile vehicles (other aircraft and vehicles required for ground operations). If the automatic control system 32 determines that the taxiing path 26 cannot be accomplished, the automatic control system 32 generates an alert destined for the pilot or removes the taxiing path 26 from the list of possible taxiing paths 26.

By way of example, the automatic control system 32, and more particularly the computer 35, are configured to obtain a precision of the order of +/−10 cm for the stopping position and of the order of +/−1 degree for the stopping orientation.

The database 28 is stored in a memory present in the aircraft 10. This memory, like the viewing screen 36, the computer 35, the input system 40, may be dedicated exclusively to the automatic piloting device. As a variant, the function of at least one of these elements can be ensured by a component already present in the aircraft 10.

The ground automatic piloting method operates in the following manner

An air traffic control post transmits to the aircraft 10 directives relating to the taxiing path 26 to be traversed and/or to the finishing point to be reached.

On the basis of these directives, the automatic control system determines at least one taxiing path 26 to be traversed.

If several taxiing paths are conceivable, the automatic control system 32 asks the pilot to choose the taxiing path 26 to be traversed. Knowing the real position of the aircraft 10, the automatic control system 32 indicates to the pilot whether the chosen taxiing path 26 can be accomplished, and if the chosen taxiing path 26 cannot be accomplished, asks the pilot to formulate a new choice.

As soon as the pilot actuates the activation control 30, the automatic control system 32 determines automatically, as a function of the static and dynamic characteristics of the aircraft 10 and preferably of the climatic conditions, a sequence of taxiing instructions that it transmits to the command system(s) 20.1 to 20.4 so as to carry out the taxiing maneuvers allowing the aircraft 10 to traverse the taxiing path 26 to be traversed and to come to a standstill at the stopping position of the parking point and in the stopping orientation.

Although described applied to the taxiing paths so as to reach the parking points for the disembarking or boarding of the passengers, the invention is not limited to these paths and may be applied to all the types of ground paths of the aircraft 10 from a starting point to a finishing point. Thus, the invention can be used for the path that goes from the parking point up to the threshold of the takeoff runway. The invention can also be implemented for the so-called “Pushback” path from the parking post up to the taxiway, aimed at distancing the aircraft 10 from the installations of the airport or in order to lead the aircraft 10 to a maintenance zone.

Likewise, the ground automatic piloting device can be coupled to an obstacle detection device to avoid the risks of collision.

According to a first advantage, the invention provides a taxiing path 26 and removes the risks that the pilot's view and/or interpretation of the visual directives will be poor when approaching the parking point. It thus reduces the problems related to conditions of poor visibility (fog, snow, etc.).

According to a second advantage, the invention makes it possible to remove the risks of errors relating to the taxiing path and/or the parking point which are the source of disruption and therefore of delay and of possible incidents.

According to a third advantage, the invention makes it possible to obtain better regularity relating to the precision of the position and of the orientation in which the aircraft 10 stops. Consequently, it is possible to simplify and to reduce the costs of the airport installations required for example for the gangways for passenger boarding or disembarkation.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for automatically piloting an aircraft on the ground, the aircraft comprising a cockpit, displacement systems, at least one command system configured to pilot the displacement systems and at least one manual control configured to transmit at least one instruction to the at least one command system, wherein the method comprises, when an activation control present in the cockpit is activated, the steps:
determining at least one sequence of taxiing instructions as a function of static and dynamic characteristics of the aircraft and of a taxiing path to be traversed, and
transmitting the determined sequence of taxiing instructions to the at least one command system piloting the displacement systems of the aircraft so that the aircraft traverses the taxiing path.

2. The method according to claim 1, further comprising a step of adjusting dynamic characteristics of the aircraft as a function of at least one characteristic of the climatic conditions.

3. The method according to claim 1, further comprising the steps:
carrying out a comparison between a real value of a characteristic of the aircraft determined by a measurement system and a theoretical value of this characteristic,
determining, as a function of the comparison, at least one corrective taxiing instruction, and
transmitting the determined corrective taxiing instruction to the at least one command system.

4. The method according to claim 1, wherein the taxiing path to be traversed is determined with the help of a database and of a directive transmitted to the aircraft by an air traffic control post.

5. The method according to claim 1, further comprising a step of choosing the taxiing path to be traversed from among a list of possible taxiing paths.

6. The method according to claim 5, further comprising a step of verifying that the taxiing path to be traversed can be accomplished.

7. A device for automatically piloting an aircraft on the ground, the aircraft comprising:
a cockpit,
displacement systems,
at least one command system configured to pilot the displacement systems, and
at least one manual control configured to transmit at least one instruction to the at least one command system, wherein the device comprises:
a database comprising static and dynamic characteristics of the aircraft to make it possible to determine at least one sequence of taxiing instructions,
an activation control positioned in the cockpit and configured to be actuated by a pilot,
an automatic control system configured to:
determine in an automatic manner at least one sequence of taxiing instructions to be executed as a function of a taxiing path to be traversed,
transmit the determined sequence of taxiing instructions to the at least one command system piloting the displacement systems so that the aircraft traverses the taxiing path.

8. The device according to claim 7, further comprising at least one system for measuring at least one characteristic of the climatic conditions and wherein the automatic control system is configured to adjust the dynamic characteristics of the aircraft as a function of the measured characteristic of the climatic conditions.

9. The device according to claim 7, further comprising a measurement system configured to determine a real value of a characteristic of the aircraft and wherein the automatic control system comprises a computer configured to:
carry out a comparison between the real value of the characteristic of the aircraft determined by the measurement system and a theoretical value of this characteristic, and
determine as a function of the comparison at least one corrective taxiing instruction to be transmitted to the at least one command system.

10. The device according to claim 7, wherein the database comprises information to make it possible to determine the taxiing path to be traversed.

11. The device according to claim 7, further comprising a viewing screen.

12. The device according to claim 7, further comprising an input system configured to allow a pilot to input a directive transmitted by an air traffic control post.

13. The device according to claim 7, further comprising a wireless communication system configured to allow a ground operator to transmit taxiing instructions to the at least one command system of the aircraft.
